(19) United States
(12) Patent Application Publication
(10) Pub. No.: US 2015/0152981 A1
(43) Pub. Date: Jun. 4, 2015

(54) CABLE STAY

(71) Applicant: Martin Goodall, Boca Raton, FL (US)

(72) Inventor: Martin Goodall, Boca Raton, FL (US)

(21) Appl. No.: 14/402,793

(22) PCT Filed: Nov. 13, 2012
(86) PCT No.: PCT/US2012/064871

§ 371 Date: Nov. 21, 2014

Related U.S. Application Data
(60) Provisional application No. 61/649,902, filed on May 21, 2012.

(51) Int. Cl. F16L 3/10; A44B 99/00

(52) U.S. Cl. CPC F16L 3/1091; A44B 99/00

(57) ABSTRACT

A cable stay has a body with one or more channels on its underside through which a cable or wire passes. The body of the stay is then placed against one side of a fabric material and a back plate is placed on the other side of the fabric, flush with the body. Magnetic force attracts the back plate and the body toward one another holding both the body and the cables or wires within a channel firmly in place.

### FIELD

The present invention relates to systems and methods for holding wires, cables or cords securely in place to avoid tangling and other problems associated with loose, unsecured cords or cables.

### BACKGROUND

Cords, cables and wires of many types have a length designed for ease of use in connecting electronic objects to each other and to power sources. However, a cord may be a nuisance or a safety hazard if not restrained and/or secured adequately.

Earphone, headphone and ear bud cords, cables or wires of, for example, cellular phones, mp3 players, IPods® and the like commonly extend from the head of a user to the device while the user drives, runs, walks, jogs, exercises or performs other activities. Often, the cable(s) dangle and move about freely. As a result they may become engaged with limbs, other devices used by the user, weights in a gym or other objects and may cause annoyance, damage or may be damaged themselves.

Therefore, it is an object of the invention to provide an apparatus that overcomes deficiencies in the prior art.

Specifically, it is desirable to provide a means for restraining and securing cords, cables and wires upon a user to minimize their free movement and reduce their susceptibility to interference with nearby objects.

### SUMMARY

In one embodiment, aspects of the invention include a cable stay comprising a body having one or more magnets, a substantially planar bottom surface and one or more channels, and a substantially planar ferromagnetic backplate configured to be flush with the substantially planar bottom surface. The one or more channels may be one or more grooves in the substantially planar bottom surface. The one or more grooves may comprise a first groove and a second groove and may have lips capable of securing cables within the one or more grooves. The first groove and the second groove may intersect.

The cable stay may have an aligning structure on the backplate and a structure on the bottom surface of the body capable of interacting with the aligning structure. The aligning structure may comprise one or more structures selected from the group consisting of a nub, a dimple, a groove and a ridge. The structure on the bottom surface of the body may comprise a structure selected from the group consisting of a dimple, a nub, a ridge, a groove and an intersection of a first groove and a second groove.

In some embodiments, the cable stay may further comprise one or more groove covers capable of being removably affixed to the bottom surface of the body and/or the cables. The one or more grooves may comprise a first groove and a second groove that may intersect. The cable stay may include an aligning structure on the backplate and a structure on the one or more groove covers capable of interacting with the aligning structure. The aligning structure may comprise one or more structures selected from a nub, a dimple, a ridge and a groove. The structure on the bottom surface of the body may comprise one or more structures selected from the group consisting of a dimple, a nub, a groove and a ridge.

In some embodiments, the cable stay may include channels comprised of one or more conduits through which one or more cables pass. The cable stay may be integral with one or more cables or may be permanently or removably affixed to one or more cables. The cable stay may be slidably affixed to the one or more cables. The cable stay may also comprise an aligning structure on the backplate corresponding to an aligning structure on the bottom surface of the body. The aligning structure comprises one or more structures selected from a nub, a dimple, a ridge and a groove. The structure on the bottom surface of the body comprises one or more structures selected from the group consisting of a dimple, a nub, a groove and a ridge.

Accordingly, the primary object of the present invention is to provide a device that retains one or more cables, cords, wires or the like such that they do not move about and interact with other objects.

It is a further object of the present invention to provide a stay for holding a cord or wire that uses magnetic force to hold the stay and associated cord or wire in place.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

FIG. 1 is a perspective view of a cable stay in accordance with the principles of the invention;

FIG. 2 is a side view of a cable stay in accordance with the principles of the invention;

FIG. 3 is a cut-away perspective view of a cable stay in accordance with the principles of the invention;

FIG. 4 is a bottom perspective view of the body of a cable stay in accordance with the principles of the invention;

FIG. 5 is a top perspective view of a back plate of a cable stay in accordance with the principles of the invention;

FIG. 6 is a perspective view of an alternative embodiment of a cable stay in accordance with the principles of the invention having a single channel comprising a groove ;

FIG. 7 is a perspective view of an alternative embodiment of a cable stay in accordance with the principles of the invention;

FIG. 8 is a cut-away perspective view of an alternative embodiment of a cable stay in accordance with the principles of the invention;

FIG. 9 is a perspective view of an alternative embodiment of a cable stay in accordance with the principles of the invention;

FIG. 10 is a bottom view of an alternative embodiment of a cable stay in accordance with the principles of the invention;

FIG. 11 is a perspective view of an alternative embodiment of a cable stay in accordance with the principles of the invention;

FIG. 12 is a perspective view of an alternative embodiment of a cable stay in accordance with the principles of the invention;

FIG. 13 is a perspective view of an alternative embodiment of a cable stay in accordance with the principles of the invention;

FIG. 14 is a perspective view of components of an alternative embodiment of a cable stay in accordance with the principles of the invention;

FIG. 15 is an environmental view of an embodiment of the cable stay in accordance with the principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

A cable stay in accordance with the principles of the invention has a body with one or more channels through which a cord, cable or wire passes. The body of the stay may be placed against one side of a fabric material and a back plate is placed on the other side of the fabric, flush with the body. Optionally, a back plate may adhere by adhesive or other means to a surface and the body may be removably attached by magnetic means directly to the back plate. Magnetic force may be used to attract the back plate and the body toward one another holding both the body and the cables within a channel firmly in place. As used herein, the terms “cables,” “cords” and “wires” are used interchangeably and refer generally to the cables used with earphones, headphones, microphones, audio devices such as mp3 players, cell phones and the like and may also refer to any other cables, wires or cords or the like which a person may desire to hold in place, for example power cords, USB cords and other cords or cables used to connect electronic equipment such as a computer and other hardware. Also as used herein, “magnetic,” and “ferromagnetic” are generally used interchangeably and generally refer to the characteristic of experiencing a force caused by a nearby magnetic field that generally causes attraction between a magnet and a metal or an opposite pole of another magnet. “Ferromagnetic” also is inclusive of “ferrimagnetic” and other types of magnetism generally accepted as types or categories of magnetism and ferromagnetism. Similarly, the term “magnetic” is inclusive of “ferromagnetic.”

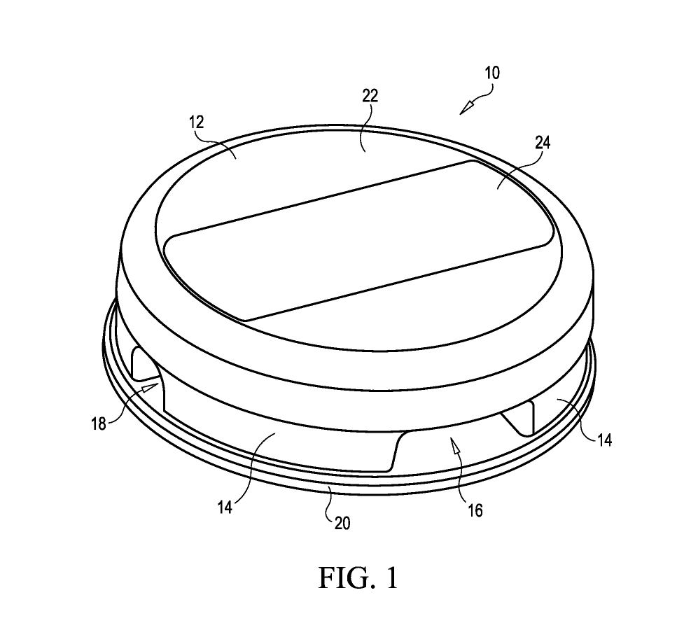

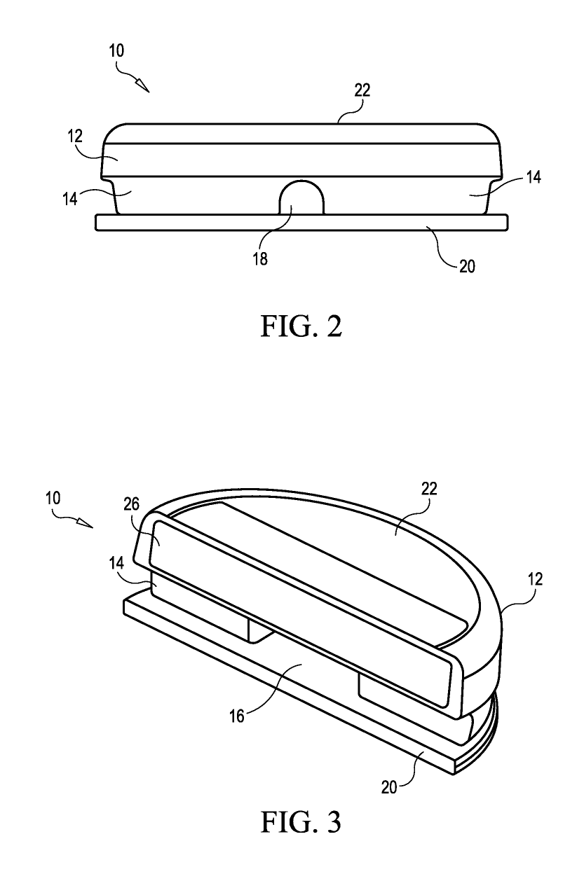

FIGS. 1-5 show a cable stay 10 in accordance with the principles of the invention. The stay 10 may have a body 12 that may be substantially cylindrical and may include four sections 14 that comprise the bottom of the body 12 and create a substantially planar bottom surface. A wide channel 16 and a narrow channel 18 may be formed between the sections 14. The body 12 may have a substantially flat, circular surface 22 that may optionally include ornamentation 24 such as, for example, a logo or other artwork. Optionally the ornamentation may be an image that may optionally be a relief such that top surface 22 is not flat, but conforms to the ornamentation.

FIG. 3 shows a cut-away view of the cable stay 10 cut along the axis of the narrow channel 18 and showing the intersection of the narrow channel 18 and the wide channel 16 in the center of the stay 10. In this embodiment, the body includes two channels that are substantially straight and substantially perpendicular, intersecting near the center of the body 12. It may optionally be desirable to have additional channels and may also be optionally desirable to have channels that are curved or otherwise not substantially straight. Optionally, the channels may be parallel or otherwise not intersect. Channels may also optionally have a width that varies along its length or otherwise not have a uniform width as channels 16 and 18 shown in FIGS. 1-4. The interior 26 of the body 12 may be hollow or filled and may optionally include a compartment that may be used to carry objects, including images, memory devices or other items.

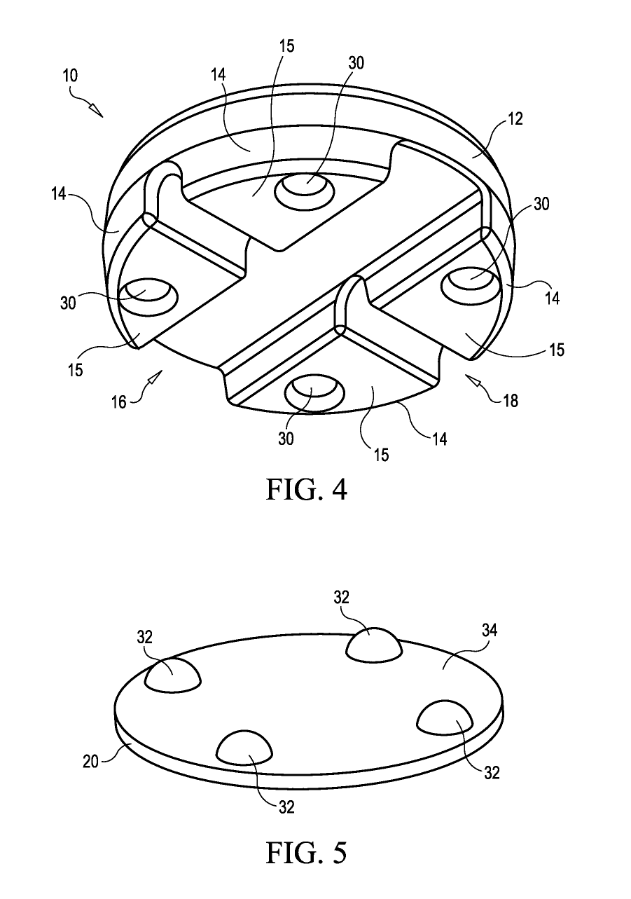

FIG. 4 shows the underside of body 12. In this embodiment, each of the sections 14 may have a substantially flat bottom 15 that collectively comprise the bottom surface of body 12. In this Figure, it may be seen that channels 16 and 18 may be grooves that extend across the bottom surface (comprising the four bottoms 15 collectively). It may be desirable for the bottom surface of the body 12 to include structures that correspond to aligning structures on the backplate 20. In this embodiment, each bottom 15 of a section 14 may have a dimple 30. The dimples 30 may be substantially cylindrical, but may optionally have a different geometry, for example hexagonal or rectangular and may also optionally be concave.

FIG. 5 shows the top surface 34 of back plate 20. In this embodiment, the back plate 20 may be a disk having a circular shape. In this embodiment, the backplate 20 has a similar shape, width and length as the body 12. However, it may be desirable for the backplate to have a shape that does not correspond to the shape of the body and may be larger or smaller than the body.

The top surface 34 may have aligning structures such as nubs 32 that may correspond to the four dimples 30 on the bottoms 15 of the sections 14. In this embodiment, the nubs 32 may be cylindrical and may be convex. However, as with the dimples 30, the nubs may have other shapes that may preferably correspond to structures on the bottom surface of the body 12. The aligning structures and corresponding structures on the bottom surface of the body 12 may prevent the body 12 and the backplate 20 from laterally sliding out of alignment with each other when placed on opposite sides of a material such as for example the cloth of a garment. Both the backplate 20 and the body 12 may encounter lateral forces caused by bumping of objects or simply the static friction of skin against the backplate 20 that may cause one or both of the body 12 and the backplate 20 to laterally slide apart and thus lose their magnetic or other engagement to one another. By including an aligning structure on the back plate and a corresponding structure on the bottom surface, these components of the invention may prevent or impede lateral movement and magnetic or other disengagement.

In operation, the backplate 20 and the body 12 may be placed on opposite sides of a thin flexible material such as an article of clothing which may decrease the friction between the back plate 20 and the pads 14. The dimples 30 and corresponding nubs 32 may prevent lateral movement or slippage between the back plate 20 and pads 14.

The back plate 20 and the body 12 may be mutually attracted by magnetic force. The back plate may be magnetic, ferromagnetic or otherwise responsive to or capable of creating a magnetic field. Similarly, the body may be ferromagnetic or otherwise responsive to or capable of creating a magnetic field and may be metal or a magnet. When the back plate is placed on one side of a material, such as for example, a shirt, and the body is placed on the other side of a thin material, they may attract one another and hold one another in place at a chosen location on the material. The interaction of structures such as the dimples and nubs may prevent the stay from moving about the material. The channels may have a cross sectional area equal to, less than or greater than the cross sectional area of one or more cables or wires such as, for example, the wires for headphones or ear buds. The walls of the channels may frictionally engage cables or wires within them to prevent them from sliding through the channels or may not be designed to enhance frictional engagement with items placed within them. The walls of the channels may optionally include a rubberized coating to enhance gripping of cables or wires within the channels. In this embodiment the two channels may have different sizes. A stay in accordance with the principles of the invention may optionally have a single channel or more than two channels. The channels may be straight, bent or curved and may be parallel, perpendicular or at another angle or may be skewed.

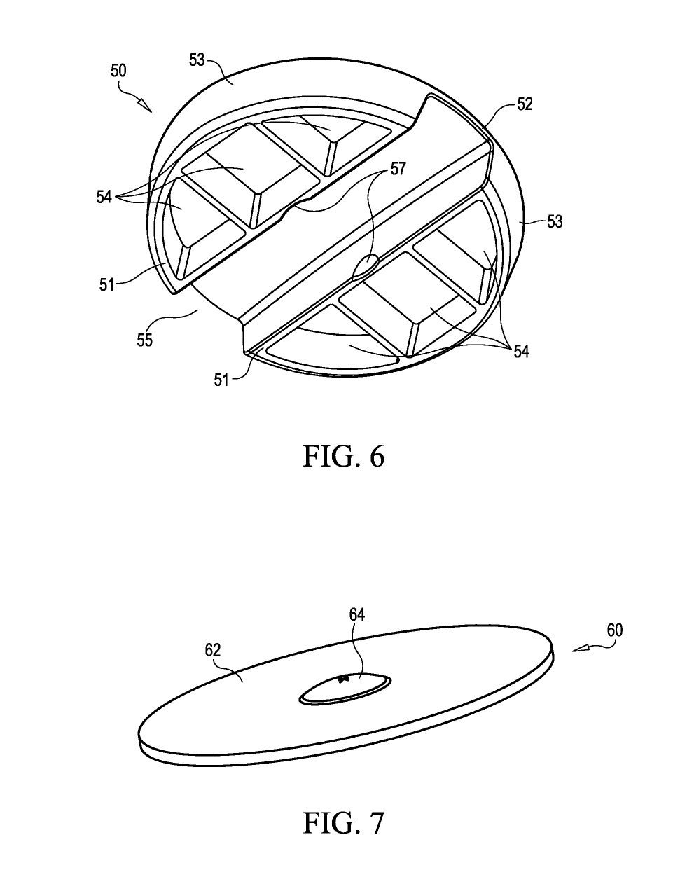

FIG. 6 shows an alternative embodiment of a stay 50 in accordance with the principles of the invention. The body 52 may be cylindrical and similarly shaped to the body 12 of stay 10 in FIGS. 1-5. Body 52 has two sections 53, defined by section walls 51, whose bottom surfaces have been removed to reveal chambers 54, one or more of which may house magnets, not shown. The bottom surfaces of sections 53 together form a bottom surface for the body. Optionally, the sections 53 do not include a bottom surface such that the bottom surface of the body 50 may be comprised only of bottom of the section walls 51. A single channel 55 may be a groove between the two sections 53 and defined by the section walls 51. In this embodiment, the channel 55 comprises a straight groove defined on either side by section walls 51. However, the channel 55 may also be curved or otherwise nonlinear groove. The channel 55 may include structures 57, which here comprise indentions, to engage an aligning structure on a backplate, as discussed below. Back plate 60 of FIG. 7 may have substantially the same area as body 52. Both body 52 and back plate 60 are circular but may optionally be any shape, such as, for example, polygonal.

FIG. 7 shows an alternative embodiment of a backplate 60 having a top surface 62 with an aligning structure comprising a single nub 64. This nub 64 aligns with a corresponding structure that in this case is simply the negative space formed at the intersection of the channels 16 and 18. The aligning structure may be a plurality of nubs as demonstrated in FIG. 5, a single nub as shown in FIG. 7, or may be other structures. For example, the aligning structure may be a raised ridge that corresponds to the negative space created by a channel or other groove. A structure on a bottom surface of a body may be a structure already found on the body, such as a groove serving as a channel or may be specifically formed for interacting with an aligning structure on a backplate.

Optionally, the aligning structure and their corresponding structures may be reversed, such that for example a backplate may have dimples or holes and a bottom surface of a body may have nubs. A bottom surface of a body and/or a backplate may optionally be designed to increase or decrease lateral friction with a garment or other item to which the body and backplate may be attached. For example one or both of a bottom surface of a body or a backplate may have a rubber coating, may be knurled, or may have a very low friction surface such as for example polished metal.

The backplate may optionally be attachable by adhesive or other means to a solid surface, such as for example, as wall or the back of a desk, and the body may attach directly to it in order to hold loose cables in place and avoid the knots of cables commonly found where several electronic devices are used jointly, for example a work station or desk.

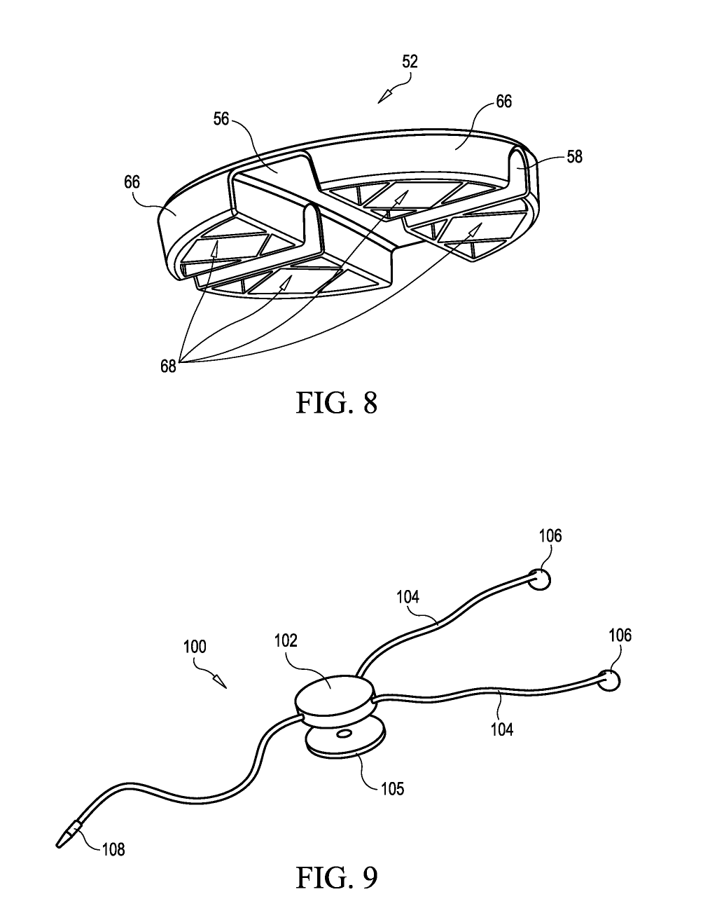

FIG. 8 shows the underside of the body 52 and compartments 68 within the sections 66. The bottom surfaces of the sections 66 have been removed to show the compartments 68 inside the sections 66. Each section 66 may have a bottom surface that collectively forms the bottom surface of the body 52. The cavities 68 may be filled with a metallic or magnetic material such that it may magnetically attract the back plate 60. The nub 64 shown in FIG. 7 may fit within the region where the channel 56 and the channel 58 intersect. In operation, the sections 14, or other portions of the body may be magnetic, ferromagnetic or ferrimagnetic or may include compartments housing magnets as shown in FIG. 8. The backplate may be magnetic, ferromagnetic or ferrimagnetic such that the backplate and the body are attracted together by magnetic force. Optionally electromagnets may be used.

FIG. 9 shows a cable stay 100 in accordance with the principles of the invention that may be integrated with cables 104 for earphones 106, such as for example for use with an mp3 player. The cable stay 102 may have a substantially flat cylindrical shape. Earphone cables 104 both attach to plug 105 and may be typically joined together for at least part of their length, usually a portion of their length adjacent to and extending from the plug 105. By necessity, a the cables 104 for a pair of earphones 106 become split apart from each other. The cable stay 102 may be integrated with the point at which the cables 104 dis-join, as shown in FIG. 9. The cable stay 102 may be molded as part of the cables during manufacture or may be formed a separate component and attached to the cables 104 at a later time. The cable stay 102 may be permanently affixed to the cables 104. A backplate 108 aligns with the cable stay 102 and uses magnetic force to retain the cable stay 102 at a desired location on a garment, article of clothing or other material. The cable stay 102 and back plate 108 may utilize dimples and nubs or other suitable structures to facilitate securement and alignment of the cable stay 102 in the desired location.

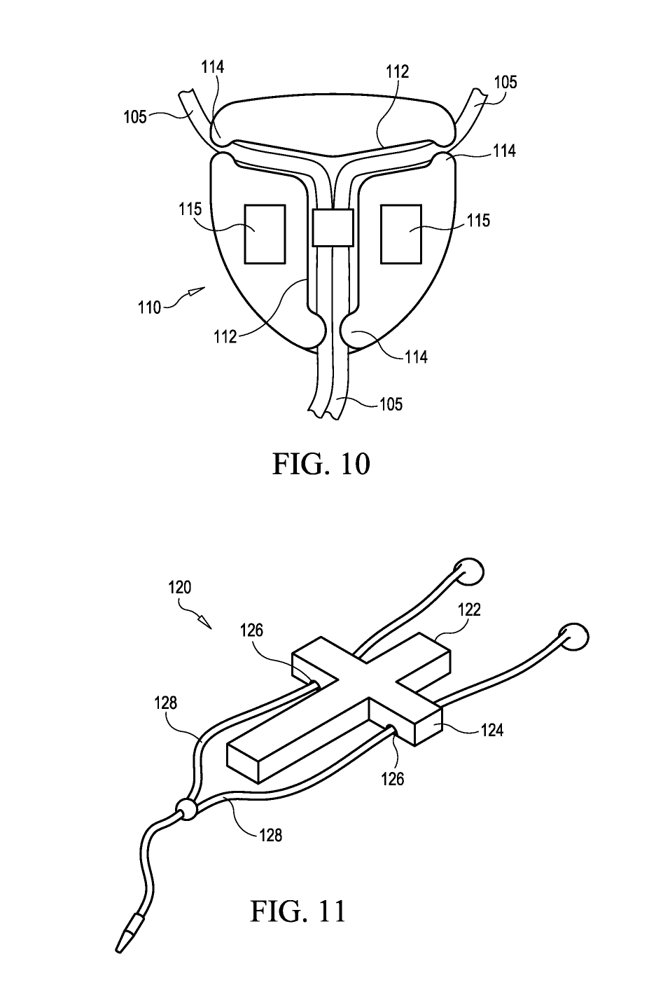

Optionally, the cable stay 102 may be removably attached to the cables 104 using a tongue and groove mechanism. FIG. 10 shows the bottom of a cable stay 110 having channels 112 to accommodate cables 105. The channels 112 may have lips 114 that may allow cables to “snap” into place in the channels and removably affix the cable stay 110 to the cables 105. The cable stay 110 may optionally use dimples and nubs or other structures to retain the cable stay in a desired location. Compartments 115 may house magnets or magnetic materials to facilitate attraction to a backplate, not shown. The cable stay 110 may be used to retrofit a cable stay to existing cables.

FIG. 11 shows an alternative embodiment of a cable stay 120 in accordance with the principles of the invention. Cable stay 120 may have a cruciform body 122. The transverse beam 124 may have two channels 126 for the cables 128 to pass through. The cable stay 120 may be permanently affixed to the cables 128 or may be removably attachable thereto. Cable stay 120 may have a back plate, not shown that is also cruciform or may be of any shape, including a disk, so long as it may interact, magnetically or otherwise, with the cable stay 120 to hold it in the desired location. All or a portion of the body 122 may be magnetic or otherwise be magnetically attracted to a backplate.

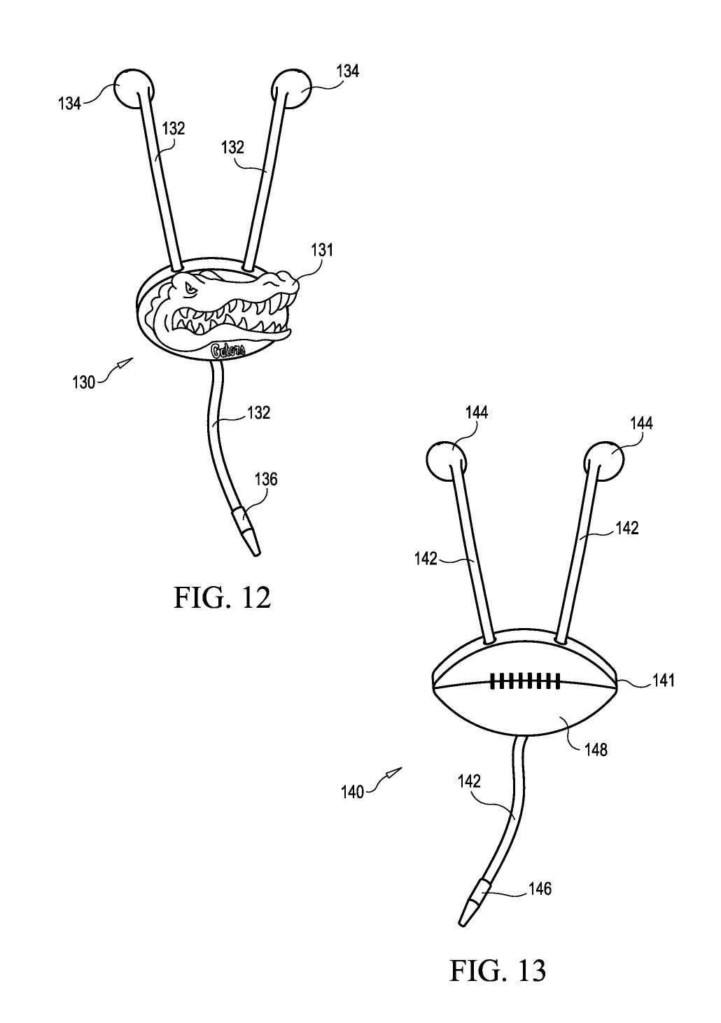

FIGS. 12 and 13 show alternative embodiments of cable stays 130 and 140 respectively. Cable stay 130 may have a body 131 having the shape of a athletic team mascot and/or logo, in this case University of Florida Gators® and may be permanently affixed or removably attached to cables 132 leading to earphones 134 from plug 136. Cable stay 140 may have a body 141 having the shape of a football or other design and may be permanently or removably affixed to cables 142. The body 141 of a cable stay 140 may optionally include ornamentation on the top surface 148. Optionally the tops surface 148 may include a trademark, logo, photograph, inlaid crystals, or other desired ornamentation. Optionally, the body may include lighting, for example, LED or fluorescent lighting, as ornamentation and may include an internal device for generating sound.

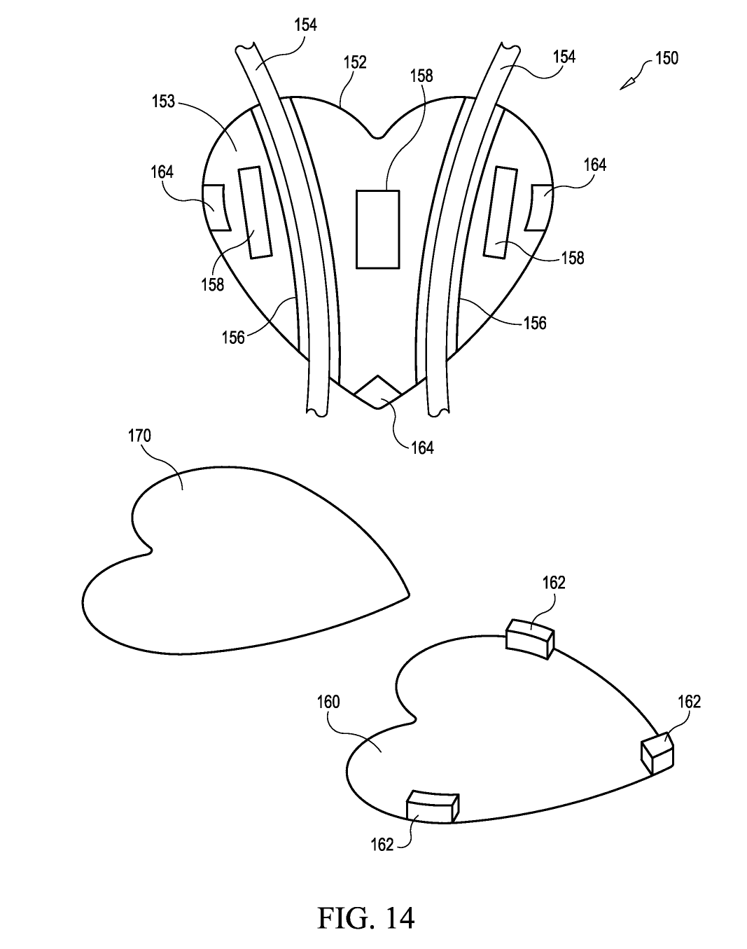

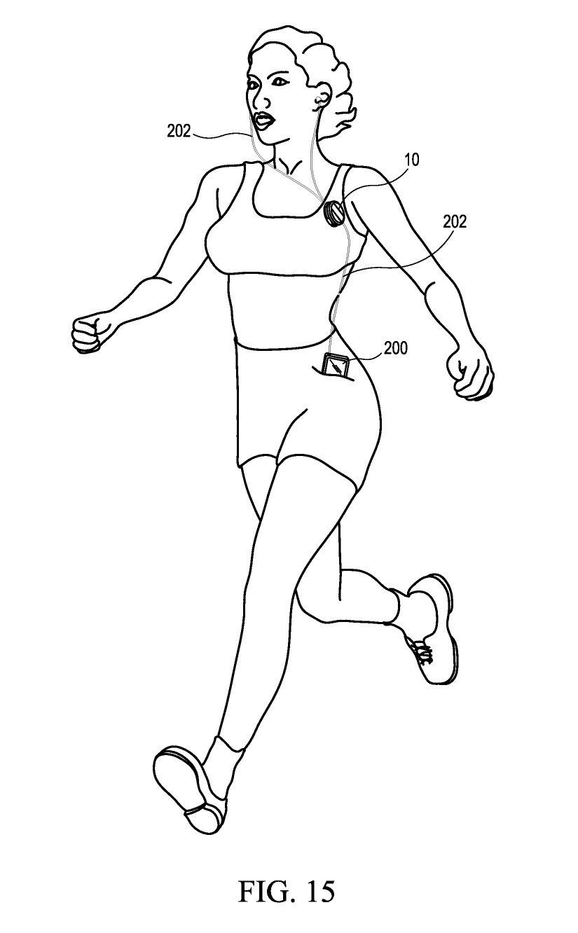

FIG. 14 shows an alternative embodiment of a cable stay 150 in accordance with the principles of the invention. Cable stay 150 may have a body 152 that may be in the shape of a heart. The body 152 may include one or more magnetic elements 158. Cables 154 may be placed in channels 156. In this embodiment, the channels 156 may not intersect, may be bent and not parallel. The cables 154 may be held in place within channels 156 by attachment of a channel cover 160. The channel cover 160 may include tabs 162 that align with and snap into slots 164 on the body 152. In this embodiment, the channel cover 160 may be a single plate covering substantially all of the bottom surface. Optionally, the channel cover 160 may be comprised of two or more channel covers. A backplate 170 may interact with the magnetic elements 158 in order to hold the cable stay 150 in the desired location on a garment of clothing or other object.

FIG. 15 shows the cable stay 10 in use. A portable mp3 player 200 is often worn while jogging, running, playing sports or exercising. Cable stay 10 may be placed at a desired location on a user's clothing. Cables 202 for the earphones are held in place by the cable stay 10. The user may move freely and rapidly without the cables 202 moving about and getting caught on objects or the user's limbs.

While the stays of the invention have been generally described in reference to use with clothing, they may be applied to any material through which a magnetic field may pass. For example, stays of the invention may be used on glass or wood structures to retain cords, cables or wires used around furniture or automobiles or in outdoor areas. In such an embodiment, rather than the stay being attached to clothing via cloth passing between the magnets, the stay is attached to the surface via some other mechanism such as glue or sticky pads attached to the bottom, while the wire continues to be trapped between the magnets of the bottom and top piece of the stay. The stays may optionally have no dimples and nubs or other structures and the underside of the pads and the top surface of the backplate(s) may be substantially planar. In addition, the bottom surfaces, channel covers and backplates have all been described as substantially planar. This encompasses both the term planar in both the Euclidean and non-Euclidean (for example the exclusion of the parallel postulate) sense, that is, the substantially planar elements may be convex or concave. It may generally be preferable for the components of an embodiment to nonetheless have congruent geometries that allow flush alignment.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A cable stay comprising:
a body having one or more magnets, a substantially planar bottom surface and one or more channels;
a substantially planar ferromagnetic back plate configured to be flush with the substantially planar bottom surface.

2. The cable stay of claim 1 wherein the one or more channels comprise one or more grooves in the substantially planar bottom surface.

3. The cable stay of claim 2 wherein the one or more grooves comprise a first groove and a second groove.

4. The cable stay of claim 2 wherein the one or more grooves include lips capable of securing cables within the one or more grooves.

5. The cable stay of claim 3 wherein the first groove and the second groove intersect.

6. The cable stay of claim 2 further comprising an aligning structure on the backplate and a structure on the bottom surface of the body capable of interacting with the aligning structure.

7. The cable stay of claim 6 wherein the aligning structure comprises one or more structures selected from the group consisting of a nub, a dimple, a groove and a ridge.

8. The cable stay of claim 7 wherein the structure on the bottom surface of the body comprises a structure selected from the group consisting of a dimple, a nub, a ridge, a groove and an intersection of a first groove and a second groove.

9. The cable stay of claim 2 further comprising a groove covers capable of being removably affixed to the bottom surface of the body.

10. The cable stay of claim 9 wherein the one or more grooves comprise a first groove and a second groove.

11. The cable stay of claim 10 wherein the first groove and the second groove intersect.

12. The cable stay of claim 11 further comprising an aligning structure on the backplate and a structure on the groove covers capable of interacting with the aligning structure.

13. The cable stay of claim 12 wherein the aligning structure comprises one or more structures selected from a nub, a dimple, a ridge and a groove.

14. The cable stay of claim 13 wherein the structure on the bottom surface of the body comprises one or more structures selected from the group consisting of a dimple, a nub, a groove and a ridge.

15. The cable stay of claim 1 wherein the channels comprise one or more conduits through which one or more cables pass.

16. The cable stay of claim 15 wherein the stay is are removably affixed to one or more cables.

17. The cable stay of claim 15 wherein the stay is slidably affixed to the one or more cables.

18. The cable stay of claim 15 further comprising an aligning structure on the backplate corresponding to an aligning structure on the bottom surface of the body.

19. The cable stay of claim 12 wherein the aligning structure comprises one or more structures selected from a nub, a dimple, a ridge and a groove.

20. The cable stay of claim 13 wherein the structure on the bottom surface of the body comprises one or more structures selected from the group consisting of a dimple, a nub, a groove and a ridge.
